(19) United States
(12) Patent Application Publication
(10) Pub. No.: US 2008/0251494 A1
(43) Pub. Date: Oct. 16, 2008

(54) Method for manufacturing circuit board

(75) Inventors: Jung-Hyun Park, Suwon-si (KR); Byoung-Youl Min, Seongnam-si (KR); Jeong-Woo Park, Suwon-si (KR); Jong-Gyu Choi, Suwon-si (KR); Ji-Eun Kim, Gwangmyeong-si (KR); Myung-Sam Kang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/078,058

(22) Filed: Mar. 26, 2008

(30) Foreign Application Priority Data
Apr. 13, 2007 (KR) 10-2007-0036510

(51) Int. Cl. H01B 13/00; C25D 5/34

(52) U.S. Cl. 216/13; 205/205

(57) ABSTRACT

A method of manufacturing a circuit board is disclosed. The method may include: forming a relievo pattern, which is in a corresponding relationship with a circuit pattern, on a metal layer that is stacked on a carrier; stacking and pressing the carrier onto an insulation layer with the relievo pattern facing the insulation layer; transcribing the metal layer and the relievo pattern into the insulation layer by removing the carrier; forming a via hole in the insulation layer on which the metal layer is transcribed; and filling the via hole and forming a plating layer over the metal layer by performing plating over the insulation layer on which the metal layer is transcribed. As the relievo pattern may be formed on the metal layer stacked on the carrier, and the relievo pattern may be transcribed into the insulation layer, high-density circuit patterns can be formed.

### CROSS-REFERENCE TO RELATED APPLICATIONS

This application claims the benefit of Korean Patent Application No. 10-2007-0036510 filed with the Korean Intellectual Property Office on Apr. 13, 2007, the disclosure of which is incorporated herein by reference in its entirety.

### BACKGROUND

1. Technical Field

The present invention relates to a method for manufacturing a circuit board.

2. Description of the Related Art

Developments in the electronics industry have promoted smaller and more functionalized electronic parts, such as in mobile phones, etc., and as a result, there is a growing demand for smaller and higher-density printed circuit boards. According to such trends towards lighter, thinner, and simpler electronic products, so also is the printed circuit board being endowed with finer patterns, smaller sizes, and packaged forms.

A technique currently in wide use for manufacturing fine circuit patterns is photolithography, which is a method of forming patterns on a board coated with a thin film of photoresist. When employing this method, however, as the degree of integration is increased for semiconductor components, an exposure technique for shorter frequencies may be required, in order to form fine-lined patterns.

Processes such as MSAP (modified semi-additive process), SAP (semi-additive process), etc., have also been used as methods of implementing high densities for fine-line circuit patterns, in which circuits are selectively grown on a thin copper film. However, there are difficulties in applying these methods, due to the additional infrastructure required in terms of materials and investments for new equipment, and because damage may occur on the finished circuits during the procedures for removing portions of the thin copper film that are not used as circuits, so that the target circuit width is not obtained. Furthermore, the circuit patterns formed according to such methods are exposed at the upper portion of the insulation board, so that the overall height of the board is great, and undercuts can occur at the attachment portions between the circuit patterns and the insulation board, causing the circuits to be detached from the insulation board.

Meanwhile, as electronic parts are produced to allow higher performance and higher density, there have appeared boards for high-density surface-mounted components, such as for an SiP (system in package) or 3D package, etc. To respond to the demands for boards of higher densities and lower thicknesses, there is a need for high-density connections between different circuit pattern layers.

Methods of electrically interconnecting layers in a multilayer printed circuit board include methods of plating, methods of printing metal paste to fill via holes with a conductive material, and the so-called “B2IT” methods of implementing interlayer connection by means of conical paste bumps.

A method based on plating may include processing via holes, such as plated through-holes (PTH) and blind via holes (BVH), that penetrate the circuit layers of a multilayer circuit pattern board, and then performing copper plating over the inner perimeters of the via holes or filling the via holes with a copper plating layer, to implement connections between different circuit layers.

A method based on filling in metal paste may include processing via holes using laser, and then filling a copper (Cu) paste, etc., inside the via holes, to implement connections between circuit layers. This technique can also include arranging several core layers, each implemented with interlayer connections, and then collectively attaching the core layers together while applying heat and pressure, to allow the exchange of electrical signals between different circuit layers.

A “B2IT” method may include printing a special conductive paste in a pyramid-like shape onto a copper foil, curing the paste to form paste studs, and having the paste studs penetrate an insulation layer and hot-pressing, to implement connections between different circuit layers.

However, the methods described above may be limited in applications involving high-density interconnections, and thus may not be utilized as complete production techniques.

FIGS. 1A to 1C are cross-sectional views representing a flow diagram for a method of interconnecting layers in a circuit board according to the related art. Referring to FIGS. 1A to 1C, via holes 108 may be processed in an insulator 104 having buried circuit patterns 106, and a seed layer may be formed that serves as an electrode for electroplating, after which a plating resist 102 may be stacked in which windows are selectively formed for filling the via holes 108. Then, electroplating may be performed using the seed layer as an electrode, to fill a conductive material 112 in the via holes 108, and the plating resist 102 may be removed, to form vias that interconnect the circuit patterns 106 formed on either side of the insulator 104. The exposed surfaces of the vias may be utilized as lands for the mounting of electronic parts, or as lands for connecting to other vias.

In this method of interconnection according to the related art, windows may be formed by exposure and development processes after applying a resist, in order to fill the via holes 108. Here, a window may be opened to a size greater than the outer diameter of the via hole 108, due to the occurrence of tolerances, etc., during the exposure process. Consequently, when the conductive material 112 is filled in the via hole 108, the land of the via may be formed wider, in correspondence with the opened window, to pose a limit to implementing fine-lined circuit patterns, as well as to lower the degree of freedom in circuit design.

Furthermore, portions of the lands may protrude outwards from the surface of the insulator, and may increase the overall thickness of the circuit board, posing a limit to providing a thin circuit board.

### SUMMARY

An aspect of the invention is to provide a method of manufacturing a circuit board, by which circuit patterns can be formed with high densities.

Another aspect of the invention is to provide a method of manufacturing a circuit board, which enables high-density interconnections between circuit pattern layers in a multilayer printed circuit board, to thereby provide a greater degree of freedom in circuit design, higher density circuits, and thinner boards, and which can decrease the size of lands in the circuit board.

One aspect of the invention provides a method of manufacturing a circuit board, where the method includes: forming a relievo pattern, which is in a corresponding relationship with a circuit pattern, on a metal layer that is stacked on a carrier; stacking and pressing the carrier onto an insulation layer with the relievo pattern facing the insulation layer; transcribing the metal layer and the relievo pattern into the insulation layer by removing the carrier; forming a via hole in the insulation layer on which the metal layer is transcribed; and filling the via hole and forming a plating layer over the metal layer by performing plating over the insulation layer on which the metal layer is transcribed.

After forming the via hole, an operation of forming a seed layer in the via hole may additionally be included, in which case the forming of the plating layer can be performed by performing electroplating using the metal layer and the seed layer as electrodes.

The method may further include removing the plating layer and removing the metal layer, after the forming of the plating layer.

The operation of forming the relievo pattern can include: selectively forming a plating resist over the metal layer in correspondence with the relievo pattern, performing electroplating with the metal layer as an electrode, and removing the plating resist.

The relievo pattern and the metal layer can be made from different metals.

The plating layer and the metal layer can be made from different metals.

The carrier may be a metal plate, in which case the metal layer and the metal plate can be made from different metals. Here, the metal plate or the metal layer can be made from any one of copper (Cu), chromium (Cr), nickel (Ni), silver (Ag), gold (Au), and aluminum (Al).

In cases where the carrier is a metal plate, the transcribing may be performed by etching the metal plate.

The operation of forming the via hole may include: removing portions of the metal layer, the circuit pattern, and the insulation layer by way of CO₂ laser; and removing remaining portions of the insulation layer by way of YAG laser.

The forming of the via hole can be performed by way of a CNC (computer numerical control) drill or a laser drill.

The laser may include at least one of CO₂ laser and YAG laser.

Forming the relievo pattern can include forming the relievo pattern on the metal layer of each of two carriers, and the pressing can include stacking and pressing each of the two carriers onto either side of the insulation layer with the relievo patterns facing each other.

Additional aspects and advantages of the present invention will be set forth in part in the description which follows, and in part will be obvious from the description, or may be learned by practice of the invention.

### BRIEF DESCRIPTION OF THE DRAWINGS

FIG. 1A, FIG. 1B, and FIG. 1C are cross-sectional views representing a flow diagram for a method of interconnecting layers in a circuit board according to the related art.

FIG. 2 is a flowchart illustrating a method of manufacturing a circuit board according to an embodiment of the present invention.

FIG. 3A, FIG. 3B, FIG. 3C, FIG. 3D, FIG. 3E, FIG. 3F, FIG. 3G, FIG. 3H, FIG. 3I, FIG. 3J, and FIG. 3K are cross-sectional views representing a flow diagram for a method of manufacturing a circuit board according to an embodiment of the present invention.

FIG. 4 is a cross-sectional view of a circuit board according to a first disclosed embodiment of the present invention.

FIG. 5 is a cross-sectional view of a circuit board according to a second disclosed embodiment of the present invention.

FIG. 6 is a cross-sectional view of a circuit board according to a third disclosed embodiment of the present invention.

FIG. 7A and FIG. 7B are cross-sectional views representing a flow diagram for a method of forming a via hole according to an embodiment of the present invention.

FIG. 8A, FIG. 8B, and FIG. 8C are cross-sectional views representing a flow diagram for a method of forming a via hole according to another embodiment of the present invention.

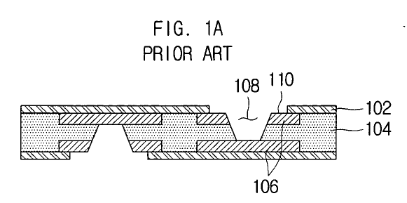

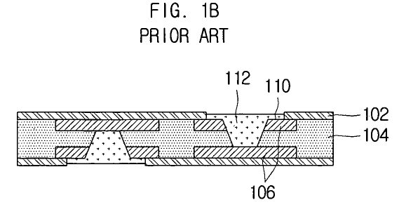

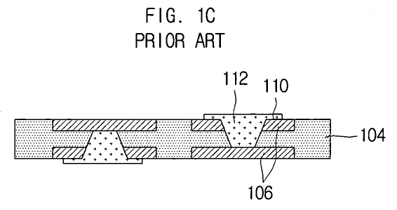

### DETAILED DESCRIPTION

The method of manufacturing a circuit board according to certain embodiments of the invention will be described below in more detail with reference to the accompanying drawings. Those components that are the same or are in correspondence are rendered the same reference numeral regardless of the figure number, and redundant explanations are omitted.

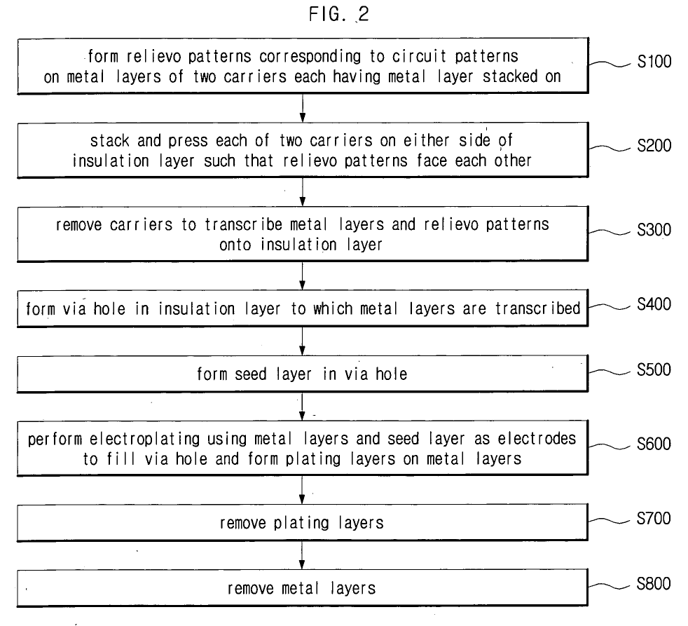

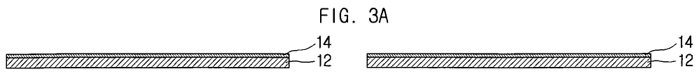

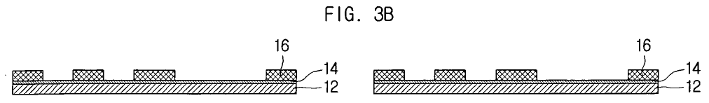

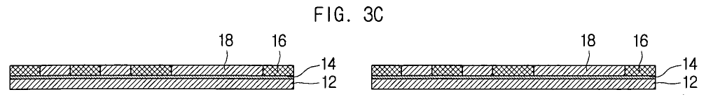

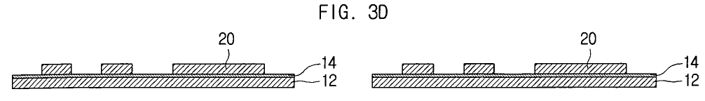

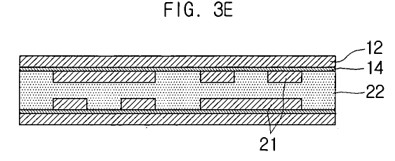

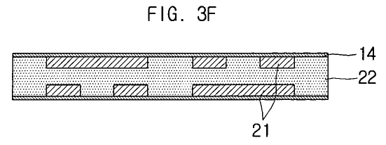

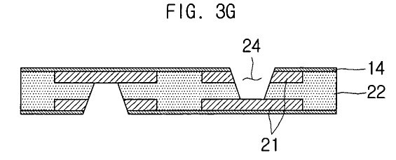

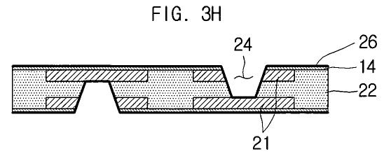

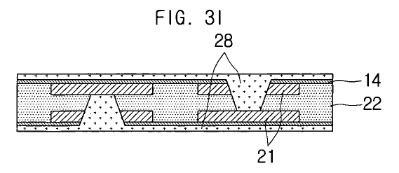

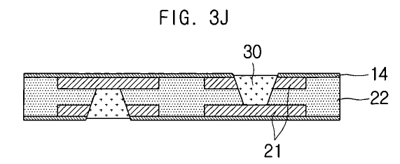

FIG. 2 is a flowchart illustrating a method of manufacturing a circuit board according to an embodiment of the present invention, and FIG. 3A through FIG. 3K are cross-sectional views representing a flow diagram for a method of manufacturing a circuit board according to an embodiment of the present invention. In FIGS. 3A to 3K, there are illustrated carriers 12, metal layers 14, plating resists 16, a conductive material 18, relievo patterns 20, circuit patterns 21, an insulation layer 22, via holes 24, seed layers 216, plating layers 28, and vias 30.

A method of manufacturing a circuit board according to this embodiment may include forming relievo patterns 20 on metal layers 14 that are stacked over carriers 12, stacking and pressing the carriers 12 onto an insulation layer 22 such that the relievo patterns 20 face the insulation layer 22, removing the carriers 12 to transcribe the metal layers 14 and the relievo patterns 20 onto the insulation layer 22, forming via holes 24 in the insulation layer 22 to which the metal layers 14 have been transcribed, and performing plating over the insulation layer 22 which the metal layers 14 have been transcribed so that the via holes 24 may be filled and plating layers 28 may be formed on the metal layers 14. This method makes it possible to form circuit patterns 21 of a high density, as well as to increase the degree of freedom in designing the circuits and to decrease the size of lands for the vias 30.

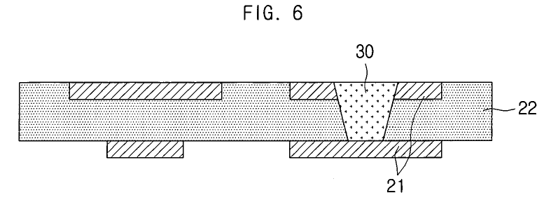

The description for this particular embodiment will focus on the case of burying the relievo patterns 20 in either side of the insulation layer 22 and forming vias 30 for interconnecting the circuit patterns 21 formed in either side. Of course, as illustrated in FIG. 6, it is also possible to form a buried circuit pattern 21 in one side of the insulation layer 22 and a protruding circuit pattern 21 on the other side of the insulation layer 22, with the vias 30 formed to interconnect the circuit patterns 21 on either side.

In this particular embodiment, in order to form the circuit patterns 21 on either side of the insulation layer 22, a relievo pattern 21 corresponding to the circuit pattern 21 to be formed on one side of the insulation layer 22 may be formed on one carrier 12, and a relievo pattern 20 corresponding to the circuit pattern 21 to be formed on the other side of the insulation layer 22 may be formed on another carrier 12. Then, the two carriers can be stacked on the insulation layer 22 to face the insulation layer and pressed together, so that the circuit patterns 21 may be formed on either side of the insulation layer 22.

To this end, the relievo pattern 20 may first be formed on the metal layer 14 of each of the two carriers 12, for carriers 12 each having a metal layer 14 stacked on. If the carriers 12 are metal plates, the metal layer 14 formed on one side of each of the carriers 12 can be made of a metal that is different from that used for the metal plate, i.e. the carrier 12. The metal plate or the metal layer 14 can be made from one of copper (Cu), chromium (Cr), nickel (Ni), silver (Ag), gold (Au), and aluminum (Al). However, the materials for the metal plate and the metal layer 14 may be different metals. For example, if a copper plate is used for the carrier 12, a material other than copper (Cu), such as nickel (Ni), may be used for the metal layer 14.

In order to stack a metal layer 14 made of nickel (Ni) over a carrier 12 made of a copper plate, electroplating may be performed using the copper plate as an electrode, to form a nickel (Ni) layer on one side of the copper plate (FIG. 3A).

On the other hand, in cases where the carrier 12 is made of an insulating material, for example, it is possible also to apply an adhesive and attach the metal layer 14 to one side of the carrier 12, and then form the relievo pattern 20 on the metal layer 14 attached to the carrier 12.

A method of forming a relievo pattern corresponding to a circuit pattern 21 on the metal layer 14 of a carrier 12 can include selectively forming a plating resist 16 on the metal layer 14 to correspond with the relievo pattern 20, performing electroplating using the metal layer 14 as an electrode such that the areas where the plating resist 16 is not formed are filled in, and then removing the plating resist 16, to form the relievo pattern 20 over the carrier 12. Here, the relievo pattern 20 and the metal layer 14 can be made of different metals. One reason for this can be to selectively remove the metal layer with respect to the circuit pattern 14, in a process of removing the metal layers 14, as described later.

In forming the relievo patterns 20 on the metal layers 14 of the carriers 12 having the metal layers 14 stacked on, plating resists 16 may be formed by coating resists and selectively performing exposure and development processes, etc., in correspondence to the relievo patterns 20 (FIG. 3B). When the plating resists 16 corresponding to the relievo patterns 20 are formed, electroplating may be performed, using the metal layers 14 as electrodes, to fill in a conductive material 18 in areas where the plating resists 16 are not formed, after which the plating resists 16 may be stripped off, to form the relievo patterns 20 on the metal layers 14 of the carriers 12 (FIGS. 3C and 3D). A method of filling the conductive material 18 into areas where the plating resists 16 are not formed can include a method of performing electroplating, using the metal layers 14 or copper plates as electrodes, and using copper (Cu), which is the same material as that of the carriers 12, for the conductive material 18. (S100)

After forming the relievo pattern 20 on the metal layer 14 of each of the two carriers 12 using the processes described above, the two carriers may be stacked on either side of the insulation layer 22, such that the relievo patterns 20 face each other, and pressed together (FIG. 3E). Here, the insulation layer 22 can include at least one of thermoplastic resin and glass epoxy resin, where the insulation layer 22 can be in a deformable state when the relievo patterns 20 formed on the metal layers 14 of the carriers 12 are transcribed into the insulation layer 22. That is, the insulation board 22 can be made deformable by raising the temperature to above the transition temperature of the thermoplastic and/or glass epoxy resin, after which the carriers 12 can be stacked and pressed onto the insulation layer 22 such that the relievo patterns 20 formed in relievo on the metal layers 14 of the carriers 12 are buried in the deformable insulation board 22.

It is also possible to use prepreg for the insulation board 22, in which glass fibers are impregnated with thermosetting resin to provide a semi-cured state. (S200)

After the two carriers 12 on which the relievo patterns 20 are formed are stacked and pressed onto either side of the insulation layer 22 with the relievo patterns 20 facing each other, the carriers 12 may be removed, so that the relievo patterns 20 and metal layers 14 may be transcribed onto the insulation layer 22 (FIG. 3F).

In cases where the carriers 12 are made from metal plates, the carriers 12 can be removed by applying an etchant that corresponds to the material of the metal plates. Here, different metals can be used for the metal plate and the metal layer 14, to allow selective removal for the carrier 12 made from the metal plate.

In certain cases, the carriers 12 can be made from insulating materials, and the metal layers 14 can be formed on the surfaces of the carriers 12 by way of a layer of thermoplastic adhesive. Then, it is possible to stack and press the carriers onto the insulation layer 22 such that the relievo patterns 20 may be buried in the insulation layer 22, after which the carriers 12 can be separated and removed by applying a certain temperature to decrease the adhesion of the adhesive layer.

When the carriers 12 are removed, the metal layers 14 and the relievo patterns 20 may be transcribed onto/into the insulation layer 22, with the relievo patterns 20 buried in the insulation layer 22 and the metal layers 14 remaining on either side of the insulation layer 22. As the relievo patterns 20 are thus buried in the insulation layer, circuit patterns 21 may be formed which are buried in the insulation layer 22. (S300)

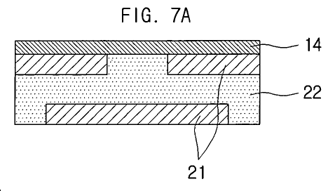

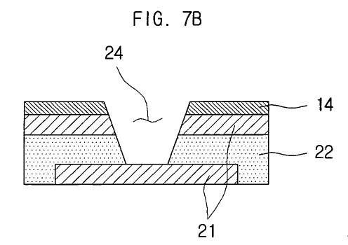

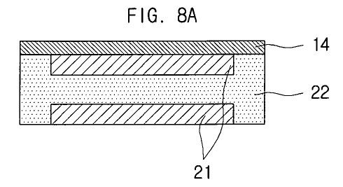

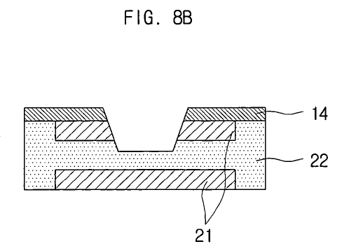

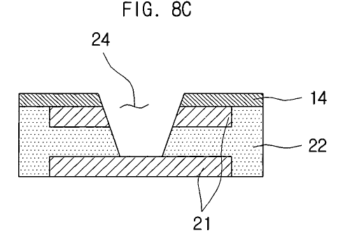

Next, when the relievo patterns 20 and the metal layers 14 are transcribed into/onto the insulation layer 22, via holes 24 may be processed for interlayer connection between the circuit patterns 21 formed on either side of the insulation layer 22 (S400, FIG. 3G). The processing of the via holes 24 will be described later in further detail with reference to FIGS. 7A to 7B and FIGS. 8A to 8C.

Next, when the via holes 24 are processed for interlayer connection in the insulation layer 22 to which the relievo patterns 20 and the metal layers 14 have been transcribed, the via holes 24 for interconnecting the circuit patterns 21 formed on either side of the insulation layer 22 may be filled in with conductive material. In this particular embodiment, this may be achieved by performing electroplating. Since electroplating requires electrodes, electroless plating may be performed over the entire insulation layer 22, to form seed layers 26 for the electroplating (S500, FIG. 3H). Afterwards, electroplating may be performed over the entire insulation layer 22, with the seed layers 26 as electrodes, whereby the via holes 24 may be filled in to form vias 30, and plating layers 28 may be formed on the outer surfaces of the metal layers 14 (FIG. 3I).

Here, the plating layers 28 can be made from different metals from those of the metal layers 14. By using different materials for the plating layers 28 and the metal layers 14, the plating layers 28 and metal layers 14 may be removed selectively in a process described later, by applying the respective corresponding etchants. (S600)

Next, after the via holes 24 are filled with conductive material, and the plating layers 28 are formed on the outer surfaces of the metal layers 14, the plating layers 28 may be removed (FIG. 3J). By using different metals for the plating layers 28 and the metal layers 14, the plating layers 28 may be selectively removed with respect to the metal layers 14. To be more specific, the plating layers 28 may be etched and removed without causing damage to the metal layers 14, by using an etchant corresponding only to the plating layers 28. As described above, in this particular embodiment, nickel (Ni) can be used for the metal layers 14, and copper (Cu) can be used for the plating layers 28, so that the plating layers 28 may be selectively removed with respect to the metal layers 14 by applying an etchant reacting to copper (Cu). (S700)

Next, with the plating layers 28 removed, the metal layers 14 may be removed also. By removing the plating layers 28 formed on the metal layers 14 and removing the metal layers 14, vias 30 may be formed for interlayer connection between the circuit patterns 21 formed on either side of the insulation layer 22 (FIG. 3K). As described above, if the circuit patterns 21 and the metal layers 14 are made of different metals, the metal layers 14 may be removed selectively with respect to the circuit patterns 21. For example, in cases where the circuit patterns 21 are made of copper (Cu) and the metal layers 14 are made of nickel (Ni), an etchant reacting to nickel (Ni) may be applied, so that the metal layers 14 may be selectively removed without causing damage to the circuit patterns 21 made of copper. (S800)

By forming circuit patterns 21 buried in the insulation layer 22 using the processes described above, it is possible to implement fine-lined circuit patterns of a high density. Since the work involved in opening windows in a resist for the forming of vias 30 can be omitted, the lands of the vias 30 can be decreased in size, allowing a greater degree of freedom in designing the circuits.

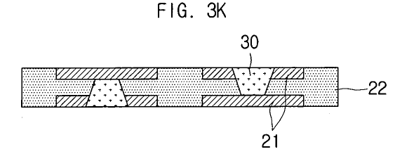

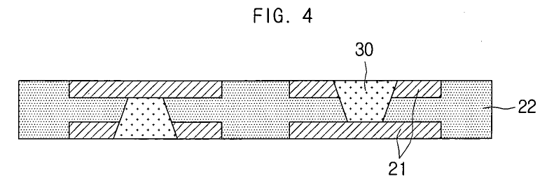

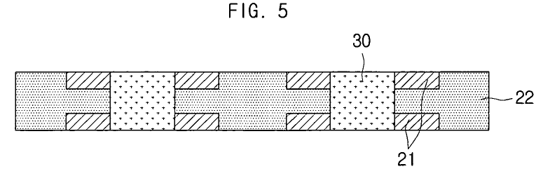

FIG. 4 is a cross-sectional view of a circuit board according to a first disclosed embodiment of the present invention, FIG. 5 is a cross-sectional view of a circuit board according to a second disclosed embodiment of the present invention, and FIG. 6 is a cross-sectional view of a circuit board according to a third disclosed embodiment of the present invention. In FIGS. 4 to 6, there are illustrated circuit patterns 21, an insulation layer 22, and vias 30.

When forming vias for interlayer connection in a circuit board according to the related art, a resist may be applied, and windows may be formed by exposure and development processes, in order to fill in the via holes. Here, due to the occurrence of exposure tolerances, the windows are formed to a greater size compared to the outer diameter of the via holes. Thus, when the via holes are filled in with conductive material, the lands for the vias may be formed wider in correspondence to the opened windows, and the lands may protrude outwards from the surface of the insulation layer, so that the overall thickness of the circuit board may be increased. In contrast, with the present embodiment, the work related to forming windows in a plating resist can be omitted, so that the size of the lands can be decreased, while the degree of freedom can be increased.

Furthermore, by using different metals for the metal layers 14 and the plating layers 28, the metal layers 14 can be selectively removed. Thus, the lands can be formed on substantially the same plane as the outer surface of the insulation layer 22, and the overall thickness of the circuit board may be decreased.

In a circuit board based on the embodiment illustrated in FIG. 4, a via 30 can have a tapered shape, with the via 30 narrowing in one direction. The via 30 can be given a tapered shape, becoming narrower towards the lower direction, if a laser is used for the processing of the via hole, where the laser may be irradiated from an upper direction to a lower direction of the drawing. In a circuit board based on the embodiment illustrated in FIG. 5, a via 30 can have a cylindrical shape. The via 30 can be given a cylindrical shape if a CNC (computer numerical control) drill is used to mechanically process the via hole. Of course, it is possible also to form a cylindrical via 30 by way of laser processing.

The circuit board according to the embodiment shown in FIG. 6 illustrates the case where a buried circuit pattern 21 is formed on one side of the insulation layer 22, and a protruding circuit pattern 21 is formed on the other side of the insulation layer 22 according to a general technique for forming circuit patterns 21, while a via 30 for interconnecting the circuit patterns 21 formed on either side of the insulation layer 22 is formed by processing a via hole from the one side to the other side of the insulation layer 22. That is, a relievo pattern, corresponding to the circuit pattern 21 that is to be formed on one side of the insulation layer 22, may be formed on the metal layer 14 using one carrier, after which the relievo pattern may be transcribed into one side of the insulation layer 22. Meanwhile, a circuit pattern 21 protruding outwards from the insulation layer 22 may be formed according to a general method of forming a circuit pattern 21 on the other side of the insulation layer 22, and a via 30 may be formed according to a method described above.

FIG. 7A and FIG. 7B are cross-sectional views representing a flow diagram for a method of forming a via hole according to an embodiment of the present invention, and FIG. 8A, FIG. 8B, and FIG. 8C are cross-sectional views representing a flow diagram for a method of forming a via hole according to another embodiment of the present invention. In FIGS. 7A to 7B and 8A to 8C, there are illustrated a metal layer 14, an insulation layer 22, circuit patterns 21, and a via hole 24.

As described above, when the relievo pattern and the metal layer 14 are transcribed into/onto the insulation layer 22, a via hole 24 may be processed to interconnect the circuit patterns 21 formed on either side of the insulation layer 22, where the processing of the via hole 24 can be performed using a CNC (computer numerical control) drill or laser drill.

The method of processing a via hole 24 using a CNC drill follows a general processing method, and thus will not be presented here in detail.

When processing the via hole 24 using a laser drill, the laser may be at least one of CO₂ laser or YAG laser. That is, the via hole 24 can be processed using CO₂ laser or YAG laser by itself, or the via hole 24 can be processed using both CO₂ laser and YAG laser in combination.

When the via hole 24 is processed by laser, the degree of drilling may vary according to the material being processed. That is, the forming of the via hole 24 may include processing portions of the metal layer 14, circuit pattern 21, and insulation layer 22, and since the materials used for the metal layer 14 and circuit pattern 21 may be different from the material used for the insulation layer 22, the degree of processing obtained by the laser being used may be different. For example, for the case of using a YAG laser drill to process a via hole 24, it is known that the degree of processing may be better for the circuit pattern 21 made of copper (Cu) than for the insulation layer 22 containing glass fibers.

FIGS. 7A and 7B illustrate a method of processing the via hole 24 using CO₂ laser or YAG laser by itself, while FIGS. 8A to 8C illustrate a method of processing the via hole 24 using both CO₂ laser and YAG laser in combination.

Referring to FIGS. 7A and 7B, the via hole 24 may be processed by sequentially processing the metal layer 14, circuit pattern 21, and insulation layer 22 using one type of laser. In this case, the intensity of the laser may be adjusted according to the degree of processing obtained by the laser for each layer, to process the via hole 24 of a predetermined form.

Referring to FIGS. 8A to 8C, the metal layer 14, the circuit pattern 21, and a portion of the insulation layer 22 may first be removed with CO₂ laser, while the remaining portion of the insulation layer 22 may be removed with YAG laser. By removing the metal layer 14, the circuit pattern 21, and a portion of the insulation layer 22 using CO₂ laser and processing the remaining portion of the insulation layer 22 with YAG laser, potential damage may be reduced on the lower circuit pattern 21.

According to certain embodiments of the invention as set forth above, a relievo pattern can be formed on a metal layer stacked on a carrier, and the relievo pattern can be transcribed into an insulation layer, whereby circuit patterns can be formed to a high density.

Also, by increasing the density of interlayer connections between circuit patterns in a multilayer printed circuit board, the degree of freedom for designing circuits can be increased, while the circuits can be implemented in higher densities and lower thicknesses.

In addition, during the process of forming vias, the exposure process can be omitted, so that not only can the sizes of the via lands be decreased, but also the manufacturing process of the circuit board can be reduced.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments other than those described above are encompassed within the scope of the present invention.

What is claimed is:

1. A method of manufacturing a circuit board, the method comprising:
forming a relievo pattern on a metal layer, the relievo pattern being in a corresponding relationship with a circuit pattern, and the metal layer stacked on a carrier;
stacking and pressing the carrier onto an insulation layer with the relievo pattern facing the insulation layer;
transcribing the metal layer and the relievo pattern onto the insulation layer by removing the carrier;
forming a via hole in the insulation layer having the metal layer transcribed thereon; and
filling the via hole and forming a plating layer over the metal layer by performing plating over the insulation layer having the metal layer transcribed thereon.

2. The method of claim 1, further comprising, after forming the via hole:
forming a seed layer in the via hole,
wherein forming the plating layer is performed by performing electroplating with the metal layer and the seed layer as electrodes.

3. The method of claim 1, further comprising, after forming the plating layer:
removing the plating layer; and
removing the metal layer.

4. The method of claim 1, wherein forming the relievo pattern comprises:
selectively forming a plating resist over the metal layer in correspondence with the relievo pattern;
performing electroplating with the metal layer as an electrode; and
removing the plating resist.

5. The method of claim 1, wherein the relievo pattern and the metal layer are made from different metals.

6. The method of claim 1, wherein the plating layer and the metal layer are made from different metals.

7. The method of claim 1, wherein the carrier is a metal plate,
and the metal layer and the metal plate are made from different metals.

8. The method of claim 7, wherein the metal plate or the metal layer is made from any one of copper (Cu), chromium (Cr), nickel (Ni), silver (Ag), gold (Au), and aluminum (Al).

9. The method of claim 1, wherein the carrier is a metal plate,
and the transcribing is performed by etching the metal plate.

10. The method of claim 1, wherein forming the via hole comprises:
removing portions of the metal layer, the circuit pattern, and the insulation layer by way of CO₂ laser; and
removing remaining portions of the insulation layer by way of YAG laser.

11. The method of claim 1, wherein forming the via hole is performed by way of a CNC (computer numerical control) drill or a laser drill.

12. The method of claim 11, wherein the laser includes at least one of CO₂ laser and YAG laser.

13. The method of claim 1, wherein forming the relievo pattern comprises:
forming the relievo pattern on the metal layer of each of two carriers,
and the pressing comprises:
stacking and pressing each of the two carriers onto either side of the insulation layer with the relievo patterns facing each other.
